(19) United States
(12) Patent Application Publication
(10) Pub. No.: US 2013/0110730 A1
(43) Pub. Date: May 2, 2013

(54) INTEGRATION OF COMPUTERIZED PROJECT PLANNING AND PROJECT DIAGRAMMING

(71) Applicants: James E. Bostick, Cedar Park, TX (US); John M. Ganci, JR., Cary, NC (US); John P. Kaemmerer, Pflugerville, TX (US); Craig M. Trim, Sylmar, CA (US)

(72) Inventors: James E. Bostick, Cedar Park, TX (US); John M. Ganci, JR., Cary, NC (US); John P. Kaemmerer, Pflugerville, TX (US); Craig M. Trim, Sylmar, CA (US)

(73) Assignee: International Business Machines Corporation, Armonk, NY (US)

(21) Appl. No.: 13/284,560

(22) Filed: Oct. 28, 2011

(51) Int. Cl. G06Q 10/06

(52) U.S. Cl. 705/301

(57) ABSTRACT

A computer implemented system and method for integrating project architecture diagramming with project planning is disclosed. A project template is stored in a database, the project template comprising at least two component tasks. The project template is associated with an architecture entity identifier. A project architecture diagram is received comprising at least one diagram entity, each diagram entity being associated with at least one diagram entity identifier. The diagram entity identifier is compared to the architecture entity identifier to identify the project template as the project template associated with the diagram entity. A project component is generated from the identified project template, the project component corresponding to the diagram entity and populated with the component tasks from the identified project template. A project work plan is populated with the project component.

### BACKGROUND

1. Field

This disclosure relates generally to computerized project management, and, more specifically, to a computer-implemented system and method for integrating computerized diagramming software and computerized project management software.

2. Background

The execution of complex projects are typically supported by project management software and diagramming software. Project management software is traditionally used to create project plans that enable project execution by coordinating time allocation, budget estimation, personnel deployment, communication, scheduling, product deployment and product testing. Diagramming software is used to produce graphic architectural diagrams illustrating project concepts such as software and/or hardware entities, data flows and system dependencies. Naturally, certain project entities may be represented on both the project plan and the architectural diagram.

Even through the project plan and the architectural diagram share much common information, the plan and diagram must nevertheless be created independently, greatly increasing the amount of labor required. Similarly, deviations between the architecture diagram and the product management plan may be inadvertently created through mishandled updates, errors, omissions and revisions. There is no easy to way to detect or correct the deviations outside of tedious manual examination of the diagram and the plan. Finally, the accessibility of information on the plan and diagram is hampered by the lack of mutual communication. Users must switch between the two documents to find in one document information referenced in one the other.

### BRIEF SUMMARY

In one aspect of this disclosure, a computer implemented method and system is disclosed that integrates project planning software and diagramming software (hereinafter, the “integrator”). The integrator functions by capitalizing on a consistent format of entities and concepts on a project architecture diagram. A project template is stored in a database, the project template comprising at least two component tasks. The project template is associated with an architecture entity identifier. A project architecture diagram is received comprising at least one diagram entity, each diagram entity being associated with at least one diagram entity identifier. The diagram entity identifier is compared to the architecture entity identifier to identify the project template as the project template associated with the diagram entity. A project component is generated from the identified project template, the project component corresponding to the diagram entity and populated with the component tasks from the identified project template. A project work plan is populated with the project component.

The foregoing has outlined rather generally the features and technical advantages of one or more embodiments of this disclosure in order that the following detailed description may be better understood. Additional features and advantages of this disclosure will be described hereinafter, which may form the subject of the claims of this application.

### BRIEF DESCRIPTION OF THE DRAWINGS

This disclosure is further described in the detailed description that follows, with reference to the drawings, in which:

FIG. 1 is a representation of two example templates utilized by the computer-implemented integrator system and method;

FIG. 1A is a representation of a task-worker table utilized by the computer-implemented integrator system and method;

FIG. 2 is a representation illustrating an example process by which the computer-implemented integrator system and method generates a project work plan from an architecture diagram;

FIG. 2A is a representation of an example generated project work plan of FIG. 2;

FIG. 3 is a high-level representation of an example computer-implemented integrator system;

FIG. 4 is a high-level representation of an example sequence of steps for implementing the example computer-implemented integrator system and method;

FIG. 6 is a high-level representation of a continuing example sequence of steps for implementing the example computer-implemented integrator system and method;

FIG. 7 is a high-level representation of a continuing example sequence of steps for implementing the example computer-implemented integrator system and method;

FIG. 8 is a high-level representation of a continuing example sequence of steps for implementing the example computer-implemented integrator system and method;

FIG. 9 is a high-level representation of a continuing example sequence of steps for implementing the example computer-implemented integrator system and method;

FIG. 10 is a high-level representation of a continuing example sequence of steps for implementing the example computer-implemented integrator system and method; and

FIG. 11 is a high-level representation of a continuing example sequence of steps for implementing the example computer-implemented integrator system and method.

### DETAILED DESCRIPTION

This application discloses a computer-implemented integrator that integrates project planning software and diagramming software. The integrator functions by capitalizing on a consistent format of entities and concepts on a project architecture diagram. Architectural diagrams may implement a consistent format of recognizable, predefined shapes, labels and other identifiers to represent project entities. For example, a hardware system project entity, such as a database, may be represented consistently with a cylinder, and labeled consistently as a “database.” The integrator disclosed herein may utilize the cylinder shape or “database” label as one or more identifiers, enabling the integrator to automatically detect the type of entity that is represented based on the identifier, retrieve a predefined template associated with the identifier, and translate the entity into a corresponding entity.

Pre-defined templates may each correspond to different types of project components, or subdivisions within the project. For example, development of a large-scale project may involve the deployment of new software, which would comprise a number of sub-tasks, such as requirements gathering, high-level software design, software architectural approval, low-level design, coding, deployment and then a number of testing levels. Software deployment may therefore be represented with a template comprising the above listed sub-tasks. Each template may be represented with an identifier corresponding to the type of entity that is represented.

When the integrator receives a project architecture diagram, the integrator may utilize the identifier to select a template for representation of an entity on the project architecture diagram. Then, using the templates, each entity may be translated into a project component on a project work plan. Each project component would be fully populated with tasks (from the template), worker assignments and information related to execution and creation of the entity. The integrator then maintains the association between the project work plan and the diagram, so updates and changes made on one are automatically reflected on the other, and information available on one is automatically available on the other as well.

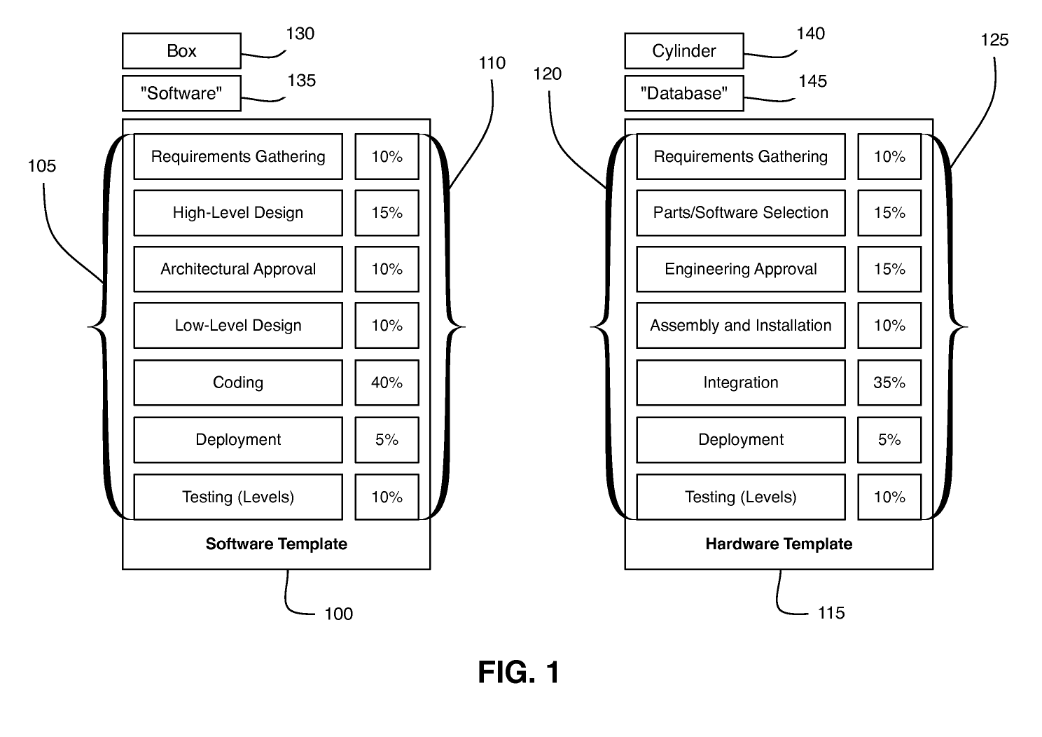

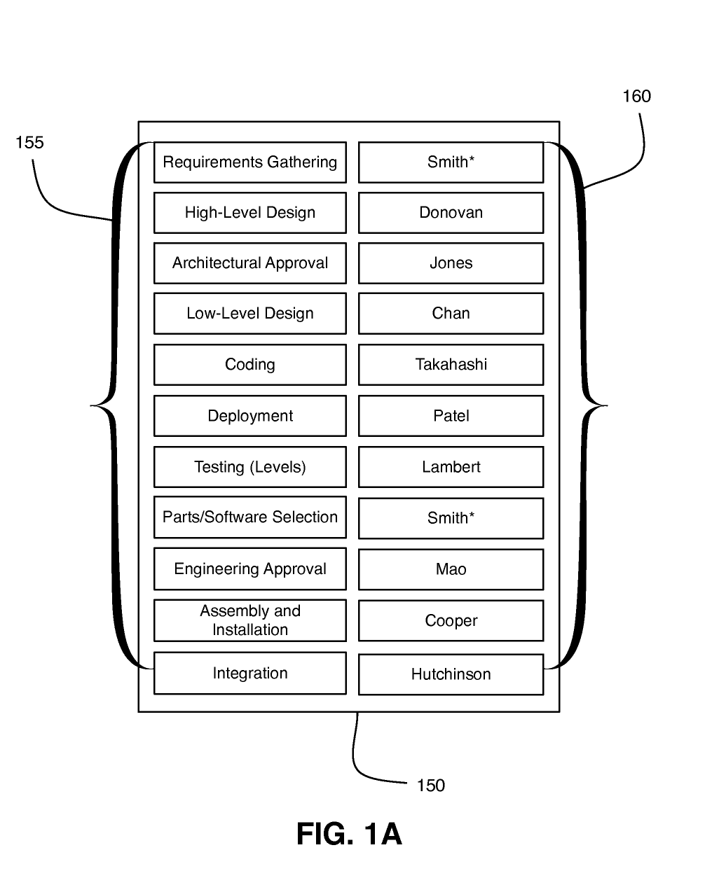

FIG. 1 illustrates two such example pre-defined templates. A software template 100 may include a list of work tasks 105, which are those tasks involved in deploying a new piece of software (as described and listed above). A list of percentages 110 may be associated with the list of work tasks, each percentage representing, for example, the amount of involvement required of each work task. This may aid in planning and scheduling execution of entities generated from the template 100. A hardware template 115 is also shown. The hardware template 115 may be populated with a slightly different list of work tasks 120, since these work tasks are poised against development and deployment of new hardware. As with the software template 100, a list of associated hardware percentages 125 may also be associated with the list of work tasks 120. Identifiers may be associated with each template. Software template 100 may be associated with a “box” shape-based identifier 130, and/or a “software” text-based identifier 135. Similarly, hardware template may be associated with a “cylinder” shape-based identifier 140, or a “database” text-based identifier 145. Any number of varying identifiers may be used, as long as they conform to the established format.

The software templates 100 and hardware template 115 may be used in conjunction with a task-worker association table to automatically generate work components on a project work plan, and then assign them to personnel. FIG. 1A illustrates an example task-worker association table 150. The task-worker association table 150 may enable the integrator to execute task assignment. A task column 155 may contain all possible tasks (generated from the work task lists 105 and 120). A worker column 160 may list the worker that is assigned to the task. Worker assignments on the task-worker association table 150 may be based on any desired factor, such as the worker's workload, specialization, education, etc. Multiple workers may be assigned to single task, and, conversely, multiple tasks may be assigned to a single worker, if desired.

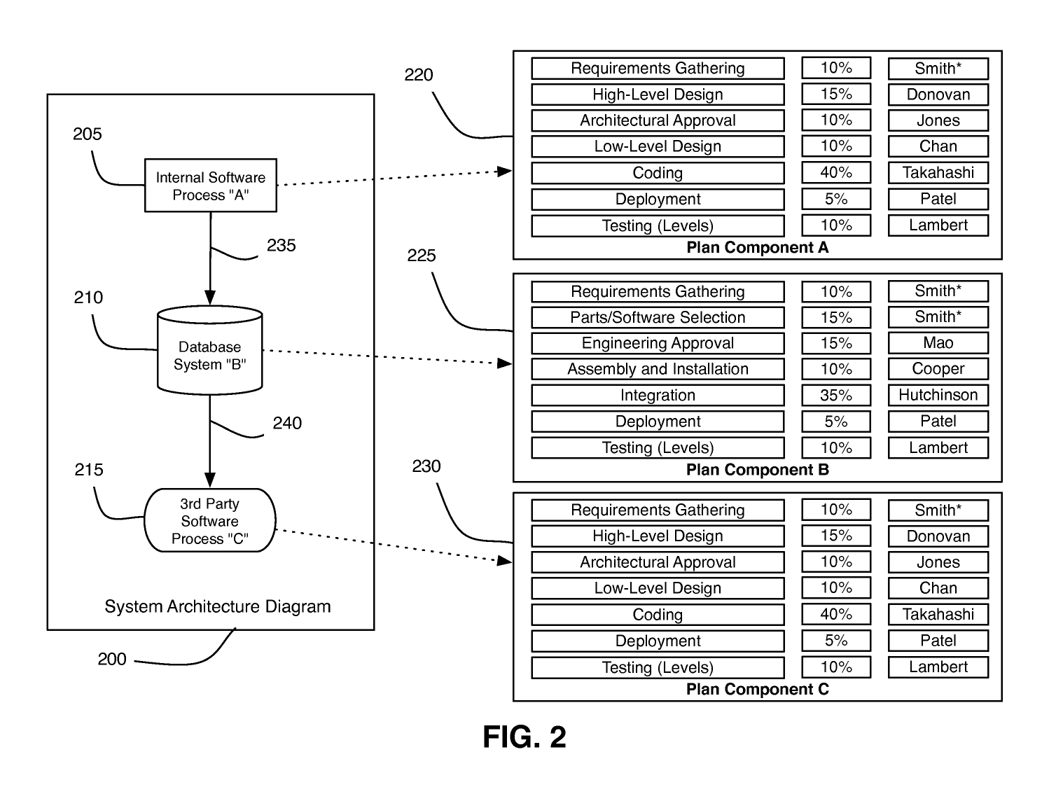

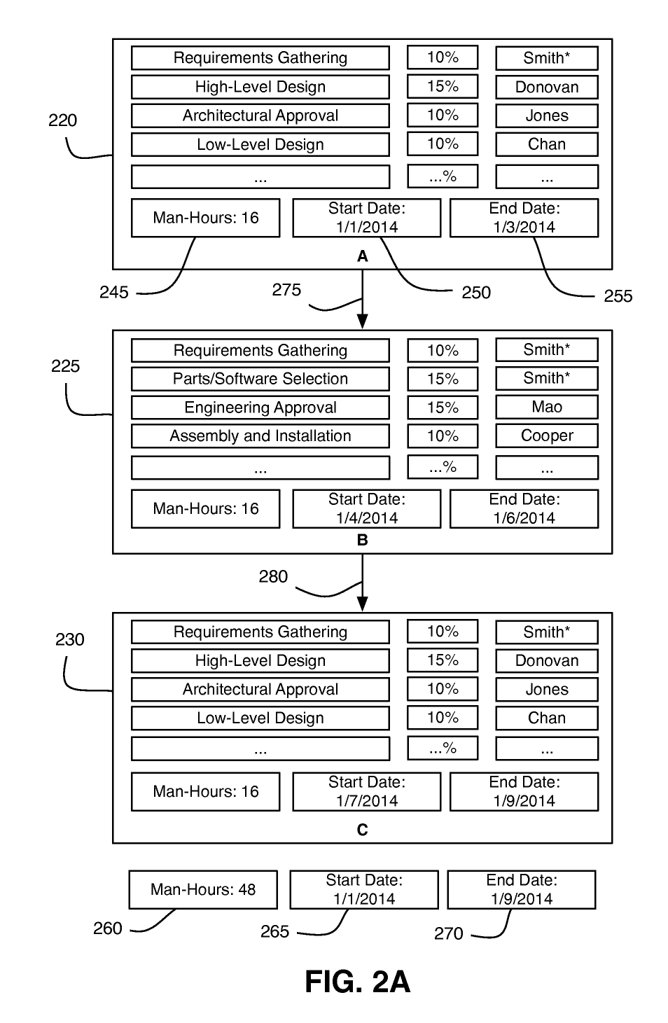

FIG. 2 is a high level representation illustrating the generation of a project work plan from a project architecture diagram. The integrator receives a pre-existing project architecture diagram 200. The integrator may process entities 205, 210 and 215 from the project architecture diagram 200 based on the relevant identifier. For example, the integrator may process the Internal Software Process “A” entity 205 based on the rectangular shape of the entity as depicted, or by the label “software.” Therefore, for the software-type entity 205, the integrator retrieves the software template 100 (from FIG. 1), because of the matching associated identifier 130 or 135, and creates a software work plan component “A” 220 from the software template 100. The work tasks in software work plan component “A” 220 are assigned to workers based on the task-worker association table 130 (from FIG. 1A). The integrator performs the same steps for the Database System “B” 210 and “3^{rd} Party Software Process “C” 215, generating plan components “B” 225 and “C” 230.

FIG. 2A is an example project work plan, as generated by the integrator from the project architecture diagram 200. The integrator 330 may populate a new project work plan with the generated plan components “A” 220, “B” 225 and “C” 230. The generated plan components “A” 220, “B” 225 and “C” 230 may be arranged in accordance with dependency indicators 235 and 240 (from FIG. 2), and marked with corresponding project work plan dependency indicators 275 and 280. Dependencies may indicate to users a plurality of concepts, such as the flow of information through the system, or a necessary order of implementation.

Each generated plan component may also include a man-hour field 245, a start date field 250 and an end-date field 255. During generation of the project work plan, the integrator 330 may ask the user input a total estimated time (such as a number of man-hours) for the completion of each plan component, and a start date for each components. Using the total number of man-hours, the integrator may determine, for example, an approximately number of man-hours to complete each task, based on the corresponding associated percentage. Similarly, using at least a start date and a known number of man-hours, the integrator 330 may calculate an end date for the plan component, which is then displayed in the end date field 255.

For example, a total of sixteen man-hours may be allocated for the generated plan component 220 (and therefore be shown in the man-hour field 245). With a start date of Jan. 1, 2014, and an average of eight man-hours per day, the integrator 330 may determine an estimated end date for the generated plan component to be Jan. 3, 2014, or two work days from the start date (shown respectively in the start date field 250 and end date field 255). The integrator 330 may also display a man-hour field total 260, start date summary 265 and end date summary 270, which summarizes the same information, but for the totality of the project. The man-hour field total 260 may comprise the total man-hour investment for all generated plan components “A” 220, “B” 225 and “C” 230. Similarly, the start date summary 265 may detail the start date for the project, which (in this case) coincides with the start date for the first generated plan component “A” 220. The end date summary 270 may similarly coincidence with the end date for the last generated plan component “C” 230.

The integrator 330 therefore provides for automatic generation of project work plans from existing project architecture diagrams. After the project work plan has been generated, the interdependency between the project architecture diagram and the project work plan may be maintained by the integrator 330, enabling, for example, mutual updating of the diagram and project work plan when a change is made to either. Similarly, information particular to project work plan, such as the man-hour fields 245, start dates 250 and end dates 255 may be made available on the project architecture diagram, eliminating the need for users to backtrack across two separate documents to find needed information. The integrator may also handle more complex dependencies, worker assignments, man-hour and end date calculations. For example, rather than the sequentially progressing example discussed above, an alternative project may have two generated plan components being executed simultaneously. As a result, the total man hour field total 260 would not be the sum of the individual man hour fields 245 for the respective generated plan components, but rather, the longer of the two (as they are being completed simultaneously). Other similarly more complex situations may be handled automatically by the computer-implemented integrator system and method disclosed herein.

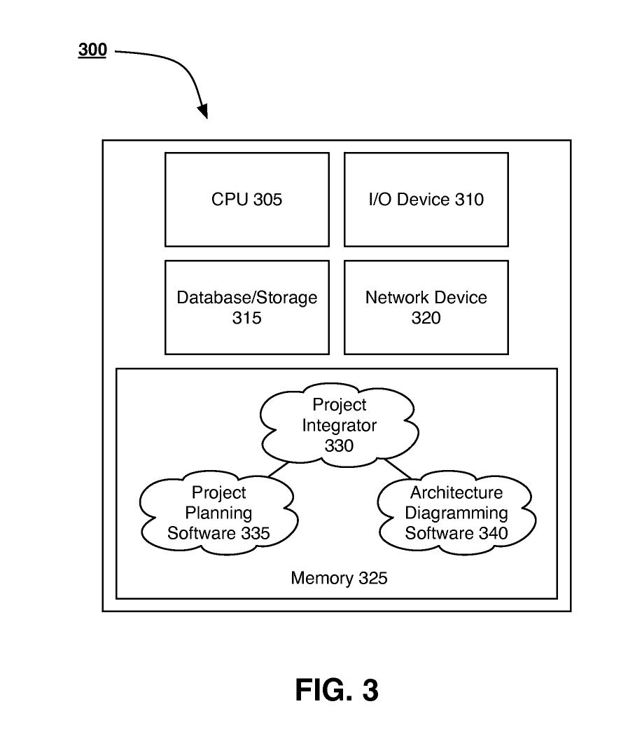

FIG. 3 is a high level representation of an illustrative software-based project planning and project diagramming integrator 330. The integrator 330 operates on a computer system 300. The computer system 300 includes computing components for executing computer program instructions and processes. These components include a central processing unit (CPU) 305, memory 325, input/output (I/O) devices 310, and a network interface 320. The CPU 305 processes and executes computer program instructions. Random access memory (RAM) 325 and/or fast access cache memory preferably provides fast data supply to CPU 305. Long-term storage 315 may be provided as a more permanent form of computer memory, and may be, for example, a hard disk, optical disk, flash memory, solid-state memory, tape, or any other type of memory. The I/O device(s) 310 permit human interaction with the computer system, such as (but not limited to) a mouse, keyboard and computer display. I/O device(s) 310 may also include other interactive devices, such as (but not limited to) touch screens, digital stylus, voice input/output, etc.

The integrator 330 may comprise a software process operating within memory 325 of the computer system 300. The integrator 330 operates in conjunction with project planning software 335 and architecture diagramming software 340. Project planning software 335 and architecture diagramming software 340 may comprise commercially available software solutions for project planning and architecture diagramming, such as Microsoft® Project®, or Microsoft® Visio®. The integrator 330 may communicate with the project planning software 335 and architecture diagramming software 340 through the use of plug-ins or other adaptive software components. The integrator 330 may also utilize a graphical user input (GUI) for interacting with, outputting information to and receiving inputs from users of the integrator 330.

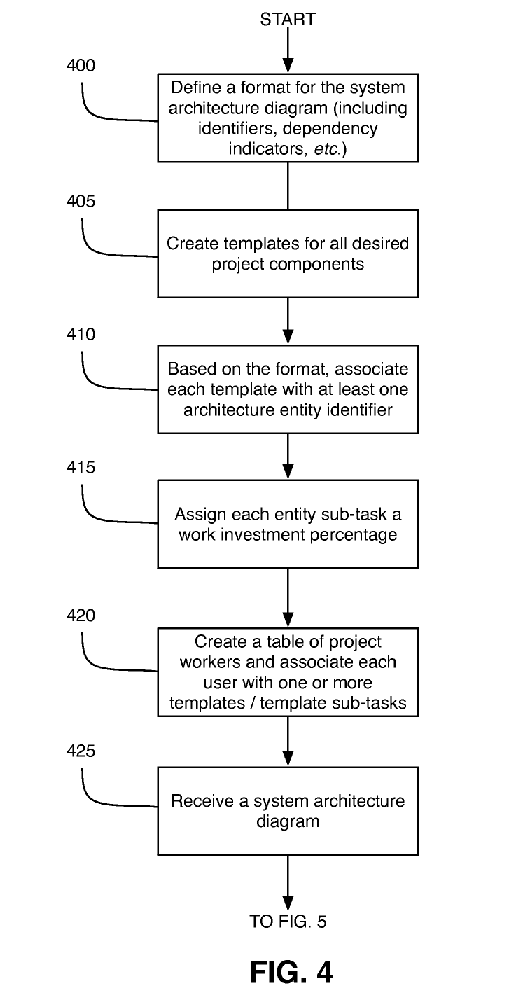

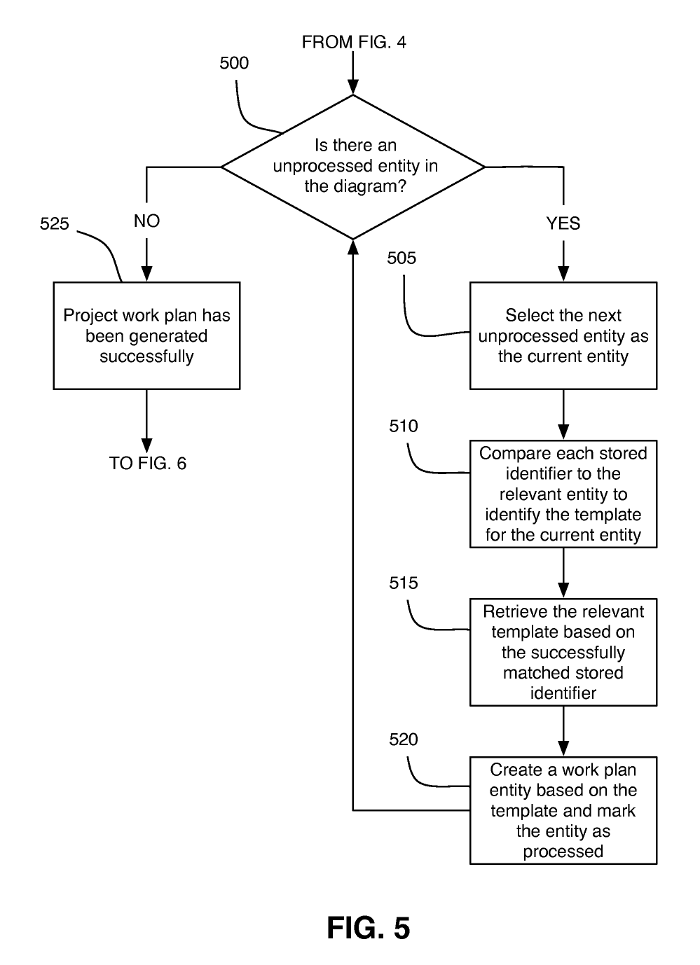

FIG. 4 is an example sequence of steps for implementing the example software-based project planning and project diagramming integrator 330 of FIG. 4. First, users may define a format for the project architecture diagram, including entity identifiers, dependency indicators and other needed representative icons, labels for representing the desired system (step 400). As described above, this is necessary to establish a consistent format that will allow the integrator 330 to automatically generate a project work plan. The format may be created informally and adhered to by the personnel responsible for creating the project architecture diagram within the architecture diagramming software 340. Alternatively, the format may be defined within the architecture diagramming software 340 and enforced by it, if included as a feature in the architecture diagramming software 340.

Subsequently, users may create templates for all to-be implemented work plan components of the prospective project work plan (step 405) (such as the software templates 100 and 115 of FIG. 1). A pre-defined template creation process operating in tangent with the GUI (such as a software “wizard”) may be implemented within the integrator 330, allowing a user to easily create a new template. The template creation process of integrator 330 may allow a user to create a new work plan component template by, for example, defining a new with a name, and then populating it with a number of work tasks (such as work tasks 105 and 120 from FIG. 1). Once the template is created, the integrator 330 may prompt the user to associate the newly created template with at least one identifier, conforming to the format established above, enabling the integrator 330 to identify the template with respect to existing architecture diagram entities (such as entities 130, 135, 140 and from FIG. 2) (step 410). Subsequently, the integrator 330 prompts the user to assign an indicator of work effort percentage to each work task (step 415).

A table of available workers for the project may be created, and each worker may be associated with one or more work tasks (step 420). As described above, these associations will be used later to automatically assign workers to work tasks, work plan components or templates. Notably, the integrator 330 may allow users to overrule the automatic assignments when desired, and/or manually assign workers to work tasks, work plan components and project work plans.

Finally, the integrator 330 receives a project architecture diagram (step 425). The integrator 330 may receive the project architecture diagram in a variety of ways. For example, the integrator 330 may retrieve the project architecture diagram from the architecture diagramming software 340 (from FIG. 1), by interfacing with the architecture diagramming software 340. Alternatively, the project architecture diagram, having been created in the architecture diagramming software 340, may be saved as a file on storage 315, and then read by the integrator 330 to retrieve the project architecture diagram. Other methods of receiving the project architecture diagram may be implemented as desired.

FIG. 5 is a continuing illustrative sequence of steps for implementing the example software-based project planning and project diagramming integrator 330 of FIG. 3. The integrator 330, having received the project architecture diagram, may then determine whether there is an entity on the project architecture diagram that has not yet been processed into a work plan component (step 500). If there is, the integrator 330 selects the next unprocessed entity on the diagram as a current entity to be processed (step 505).

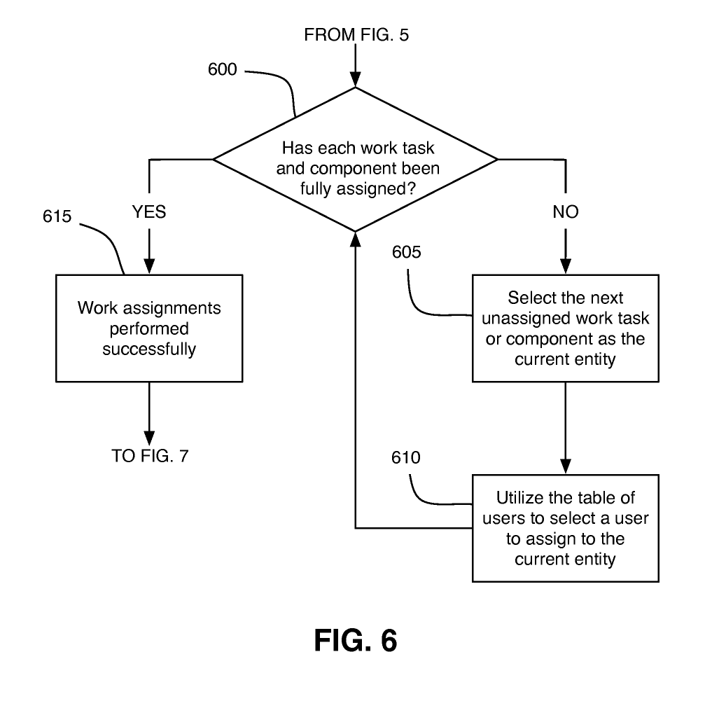

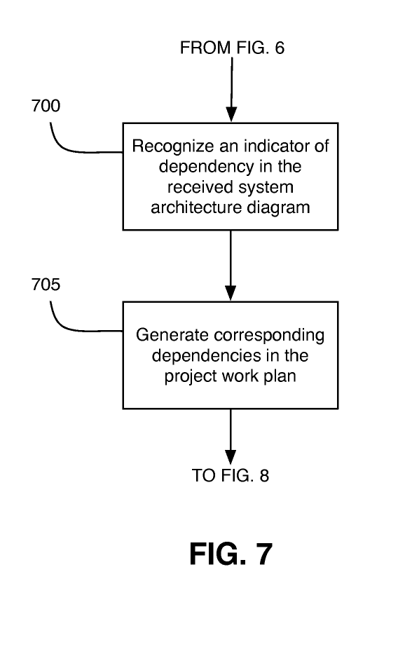

The integrator 330 then compares the relevant identifiers of the current entity to the stored entity identifiers to determine which template should be used to generate a work plan component corresponding to the current entity (step 510). For example, if the entity identifiers are labels, the integrator 330 must first obtain text related to the current entity. The integrator 330 may directly access this information by interfacing with the architecture diagramming software 340. Alternatively, the integrator 330 may utilize pattern recognition to parse text (using, for example, optical character recognition) associated with the current entity or recognize shape-based identifiers. Once the relevant identifier has been retrieved, it may be compared to the stored identifiers (from step 410) to determine which template should be associated with the current entity. Once a match has been found, the identified template may be retrieved from storage (step 515). The integrator 330 may then generate a work plan component from the identified template by, for example, interfacing with the project planning software 335 and using the appropriate in-program calls and commands to generate the component in accordance with the identified template (step 520). The integrator 330 then returns to step 500 and determines whether there is another unprocessed entity in the diagram. If there is, the process repeats. If there is not, then the project work plan is deemed to have been successfully generated (step 525), and the method may proceed to FIG. 6.

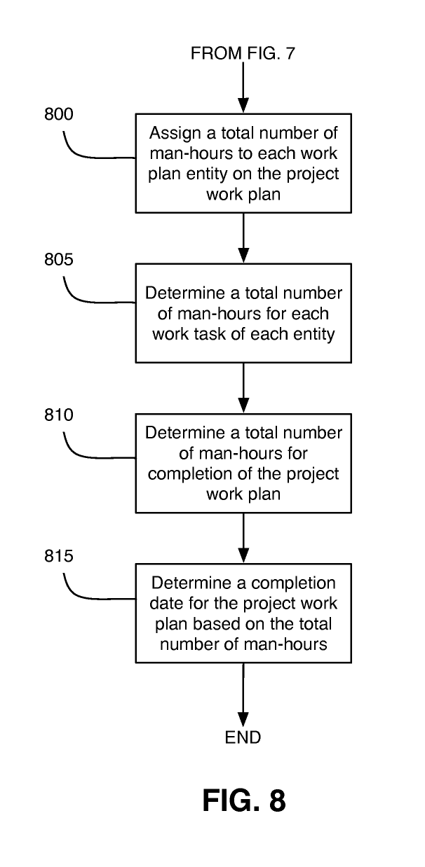

FIG. 6 is a continuing sequence of steps for implementing the example software-based project planning and project diagramming integrator 330 of FIG. 3, illustrating the process by which workers are automatically assigned to work tasks. The integrator 330 may determine whether every work task has been assigned to a worker (step 600). If not, then the integrator 330 may select the next unassigned work task as a current work task (step 605). Subsequently, the integrator 330 may select a worker based on the association of workers to work tasks (as defined in step 420). If multiple users are associated with the current work task or work plan component, and all are equally qualified, the integrator 330 may simply select one based on some pre-defined selection scheme. For example, the first name, by alphabetical order, may automatically be selected for assignment. Alternatively, more information may be associated with each worker in the table, allowing integrator 330 to make more intelligent or nuanced decisions when selecting a worker. Details such as each worker's project history, work schedule, current workload and other similar factors may aid in selecting one worker out of a plurality of associated workers. The method then returns to step 600. Once every work task has been assigned a worker, then the worker assignments may be deemed successful and the method may progress to FIG. 7 (step 615).

FIG. 7 is a continuing sequence of steps for implementing the example software-based project planning and project diagramming integrator 330 of FIG. 3, illustrating the process by which dependencies are generated in the project work plan. The integrator 330 may recognize dependency indicators in the received project architecture diagram based on the format (defined in step 400) (step 700). As described above, such indicators may be pre-defined shapes or markings such as, for example, a line with an arrow stemming from a first architecture diagram entity to a second architecture diagram entity, indicating that the first entity is a prerequisite of the second diagram, and that the second entity is dependent upon the first entity. The integrator 330 then generates corresponding marks, shapes or other desired indicators on the project work plan marking the work plan components as dependants/prerequisites in accordance with the dependency indicators on the project architecture diagram (step 705).

FIG. 8 is a preferred sequence of steps for implementing the example software-based project planning and project diagramming integrator 330 of FIG. 3, illustrating the process by which the integrator 330 may estimate the completion dates for work tasks, work plan components and the overall project work plan. The integrator 330 may request that a quantity of man-hours is assigned to each work plan component in the project work plan (step 800). Once the user has input the total number of man-hours for each work plan component, the integrator 330 may determine a total number of man-hours for each work task of each entity by utilizing the work investment percentages associated with each work task (step 805) (as established previously in step 415). Similarly, the integrator 330 may determine a total number of man-hours for completion of the project work plan by, for example, summing the total number of man-hours for each work plan component (step 810). Then, a completion date may be estimated based at least on a start date for the project and the total number of man-hours for project work plan (step 815).

The integrator 330 may also perform more complex determinations of a total number of man-hours for the completion of individual work plan components and/or the completion of the work project plan. For example, if a work plan component contains a number of work tasks that may be executed simultaneously, the integrator 330 may recognize that an estimated completion date should be formulated based on the estimated man-hour requirement to complete longest of the work tasks (as it is with a number of parallel tasks), rather than the sum of all the man-hour requirements to complete all the work tasks (as it is with a sequentially progressing set of work tasks). Even more complex determinations may be performed. For example, a work plan component may comprise a plurality of work tasks, some executed sequentially, others executed simultaneously, and others executed only when some previous work task (or a group of work tasks) has completed. Integrator 330 may in such cases traverse a “map” of the work tasks, keep separate man-hour totals for each parallel executing threads of work tasks (of which some may overlap), until all parallel threads come to a conclusion, and then select the highest man-hour total as the estimated man-hour requirement to complete the work project component. Any algorithm may be used as appropriate.

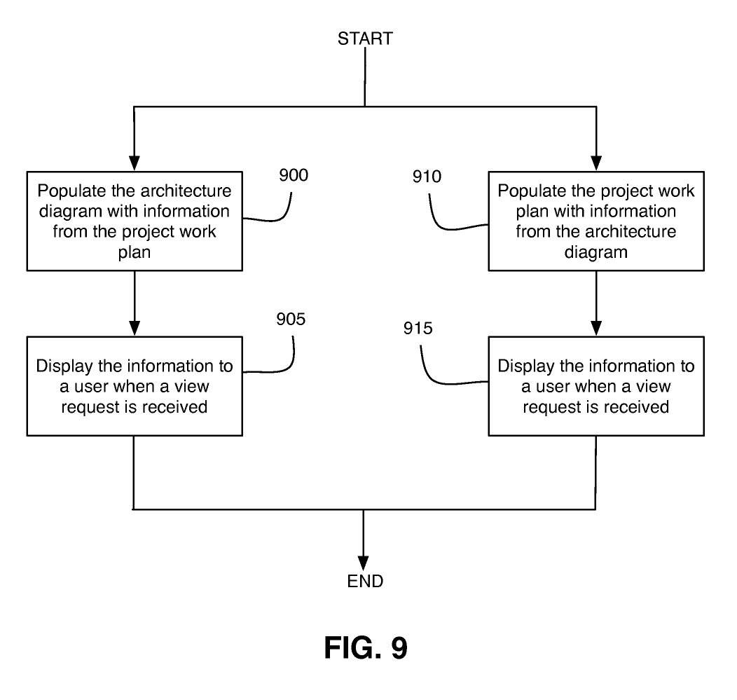

FIG. 9 is a preferred sequence of steps for implementing the example software-based project planning and project diagramming integrator 330 of FIG. 3, illustrating the process by which the integrator 330 may enable project work plan information to be displayed in the project architecture diagram. Once the project work plan has been completed, information from the project work plan may be used to populate portions of the project architecture diagram (step 900). This information need not be immediately displayed on the project architecture diagram, as doing so may clutter the appearance of the diagram, making it more difficult to understand.

Instead, the information may populate hidden fields that appear upon request. Therefore, when integrator 330 receives a request to display the information in the project architecture diagram, the hidden fields may be displayed to the user (step 905). Similarly, the integrator 330 may populate the project work plan with any information from the architecture diagram (step 910), and display this information when the user submits some request to view the information on the project work plan (step 915).

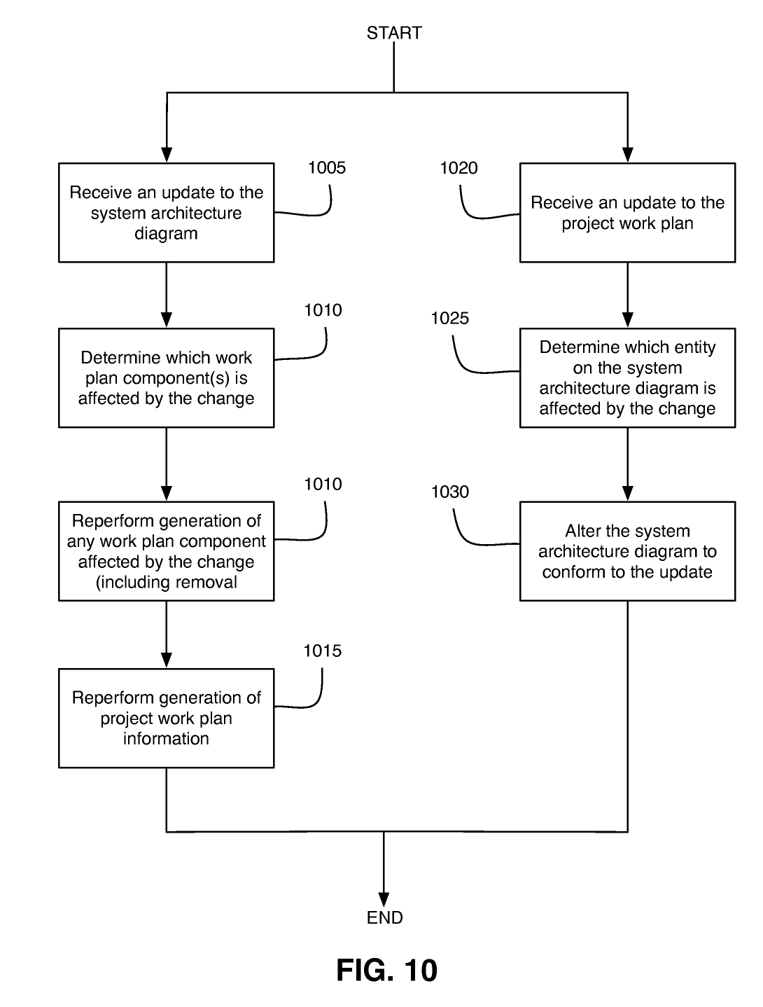

FIG. 10 is an example sequence of steps for implementing the example software-based project planning and project diagramming integrator 330 of FIG. 3, illustrating the process by which the integrator 330 may effect bilateral updating of the project architecture diagram and project work plan after the project work plan has been generated. The integrator 330 may receive an update to the project architecture diagram (step 1005). The integrator 330 may, for example, monitor the status of the project architecture diagram while it is being edited within the architecture diagramming software. When the user designates that the edits are to be executed and carried over to the project work plan, the software architecture diagram may send the edits to the integrator 330. The integrator 330 determines which work plan component (or components) is affected by the change (step 1010), based on the existing correlation between the project architecture diagram and the project work plan. Subsequently, the integrator 330 performs generation of all work plan components affected by the change according to the same process described earlier (step 1010). For example, if an entity were removed from the project architecture diagram, the integrator 330 would delete the current associated work plan component from the project work plan as a result. If an entity were slightly modified, a re-generated work plan component would reflect the modification. Finally, all information in the project work plan, such as man-hour totals 260, start date field 265 and end date field 270 (from FIG. 2A) are recalculated to capture any possible effects the changes may have had on these estimates (step 1015).

Similarly, the integrator 330 may receive an update to the project work plan (step 1020). For example, the project work plan may be edited with the project planning software 335 (from FIG. 3). When the user has completed a set of edits, he may indicate to the project planning software 335 that the changes are to be carried over to the project architecture diagram. The project planning software 335 may then send the changes to the integrator 330. The integrator 330 may then determine which entities on the project architecture diagram are affected by the changes, based on the correlation between the project architecture diagram and the project work plan (step 1025). Finally, the integrator 330 may interface with the diagramming software 340 and alter the architecture diagramming software 335 to conform to the changes made by the user (step 1030).

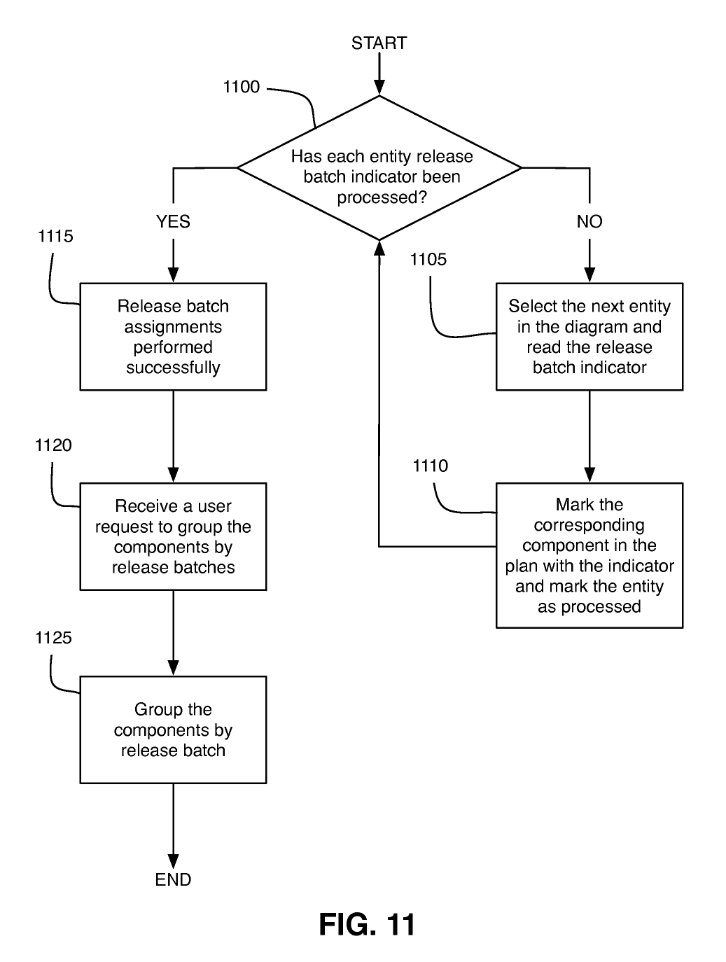

FIG. 11 is an example sequence of steps for implementing the example software-based project planning and project diagramming integrator 330 of FIG. 3, illustrating the process by which work plan components may be grouped into release batches. During the development of a project, certain segments of the project may be marked for different releases, resulting in different branches of development within the project. These different releases may be indicated by release batch indicators on the project architecture diagram. The integrator 330 first determines whether each entity on the project architecture diagram has been processed (step 1100). If not, then the integrator 330 selects the next unprocessed entity from the project architecture diagram and reads the release batch indicator (step 1105). The integrator 330 then accesses the project work plan and mark the component corresponding to the processed entity with the release batch indicator (step 1110). The process repeats until every entity release batch indicator has been processed successfully (step 1115).

The integrator 330 may at any point receive a request from a user to group the work plan components of the project work plan by release batch (step 1120). The integrator 330 may subsequently organize the work plan components by release batch so that work plan components having the same release batch indicator are placed within a single developmental branch of the project work plan (step 1125). This will ensure that a development team following the project work plan will complete all work plan components in accordance with planned release batches, as indicated on the project work plan,

The network interface device may provide the computing system with access to a network, which may be a wireless or wired connection. The network may be, for example, the Internet, a corporate intranet, or any other computer network through which the computing system may connect to or otherwise communicate with other computers and database. Software process or processes and executables on the computing system may be used to provide human interfaces (such as a graphical user interface), and to store and initiate computer program instructions used to process and analyze data. Computer program code for carrying out operations described herein may be written in any combination of one or more programming languages, including an object oriented programming language such as Java, C++, C# or the like and conventional procedural programming languages, such as the “C” programming language or similar programming languages. The program code may execute entirely on the computing system, partly on the computing system, as a stand-alone software package, partly on the computing system and partly on a remote computer or server, or entirely on a remote computer or server.

This application was described above with reference to flow chart illustrations and/or block diagrams of methods, apparatus (systems) and computer program products according to one or more embodiments. It is understood that some or all of the blocks of the flow chart illustrations and/or block diagrams, and combinations of blocks in the flow chart illustrations and/or block diagrams, can be implemented by computer program instructions. The computer program instructions may also be loaded onto the computing system to cause a series of operational steps to be performed on the computer to produce a computer implemented process such that the instructions that execute on the computer provide processes for implementing the functions/acts specified in the flowchart and/or block diagram block(s). These computer program instructions may be provided to the CPU of the computing system such that the instructions, which execute via the CPU of the computing system, create means for implementing the functions/acts specified in the flowchart and/or block diagram block(s).

These computer program instructions may also be stored in a computer-readable medium that can direct the computing system to function in a particular manner, such that the instructions stored in the computer-readable medium implement the function/act specified in the flowchart and/or block diagram block or blocks. Any combination of one or more computer usable or computer readable medium(s) may be utilized. The computer-usable or computer-readable medium may be, for example (but not limited to), an electronic, magnetic, optical, electromagnetic, infrared, or semiconductor system, apparatus, device, or propagation medium. More specific examples (a non-exhaustive list) of the computer-readable medium include the following: an electrical connection having one or more wires, a portable computer diskette, a hard disk, a random access memory, a read-only memory, an erasable programmable read-only memory (e.g., EPROM or Flash memory), an optical fiber, a portable compact disc read-only memory, an optical storage device, a transmission media such as those supporting the Internet or an intranet, or a magnetic storage device. Any medium suitable for electronically capturing, compiling, interpreting, or otherwise processing in a suitable manner, if necessary, and storing into computer memory may be used. In the context of this disclosure, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in base band or as part of a carrier wave. The computer usable program code may be transmitted using any appropriate medium, including (but not limited to) wireless, wire line, optical fiber cable, RF, etc.

Having described and illustrated the principles of this application by reference to one or more preferred embodiments, it should be apparent that the preferred embodiment(s) may be modified in arrangement and detail without departing from the principles disclosed herein and that it is intended that the application be construed as including all such modifications and variations insofar as they come within the spirit and scope of the subject matter disclosed.

What is claimed is:

1. A computer implemented method for integrating project architecture diagramming with project planning, comprising:
storing in a database a project template, the project template comprising at least two component tasks;
associating, using a processor, the project template with an architecture entity identifier;
receiving a project architecture diagram comprising at least one diagram entity, each diagram entity being associated with at least one diagram entity identifier;
comparing, using the processor, the diagram entity identifier to the architecture entity identifier to identify the project template as the project template associated with the diagram entity;
generating, using the processor, a project component from the identified project template, the project component corresponding to the diagram entity and populated with the component tasks from the identified project template; and
populating a project work plan with the project component.

2. The method of claim 1, further comprising:
parsing the diagram entity identifier to retrieve a first text;
parsing the architecture entity identifier to retrieve a second text; and
comparing the first text and the second text to execute the comparing of the diagram entity identifier to the architecture entity identifier.

3. The method of claim 1, further comprising:
obtaining shape information from the diagram entity identifier to retrieve a first shape;
obtaining shape information from the architecture entity identifier to retrieve a second shape; and
comparing the first shape to the second shape to execute the comparing of the diagram entity identifier to the architecture entity identifier.

4. The method of claim 1, further comprising:
updating the project work plan to comport with a received update to the project architecture diagram; and
updating the project architecture diagram to comport with a received update to the project work plan.

5. The method of claim 1, further comprising:
storing in the database an association between users and component tasks; and
automatically assigning users to component tasks of the project component based on the association.

6. The method of claim 1, further comprising:
accepting an indicator that a first diagram entity is a predecessor of a second diagram entity; and
automatically setting, in the project work plan, a first project component, associated with the first diagram entity, as a prerequisite dependency for a second project component, associated with the second diagram entity.

7. The method of claim 1, further comprising:
associating a work investment percentage with each component task;
receiving a component work investment necessary to complete each project component; and
determining, for each component task, a task work investment, the task work investment being a portion of the component work investment necessary to complete the component task, as based on the work investment percentage.

8. The method of claim 7, further comprising determining a completion date for the project component, based at least on a start date, the component work investment, and the task work investments for each component task of the project component.

9. The method of claim 8, further comprising determining a project completion date for the project work plan using at least the completion dates and the component work investments for each project component in the project work plan.

10. The method of claim 9, further comprising populating the received project architecture diagram with the completion dates, the component work investments, the task work investments, and the project completion date.

11. The method of claim 10, further comprising accepting edits to the start dates, component work investments, task work investments and the project completion date within the project work plan and in the project architecture diagram.

12. The method of claim 1, wherein the diagram shape is associated with a release phase indicator, the method further comprising:
designating the project work plan for a current release phase of a plurality of release phases; and
populating the project work plan with a project component corresponding to the diagram entity only when the release phase indicator for the diagram entity corresponds to the current release phase.

13. A system for integrating project architecture diagramming with project planning, comprising:
a computer processor;
a database; and
memory comprising program instructions, the program instructions executable by the processor to:
store in the database a project template, the project template comprising at least two component tasks;
associate, using the processor, the project template with an architecture entity identifier;
receive a project architecture diagram comprising at least one diagram entity, each diagram entity being associated with at least one diagram entity identifier;
compare, using the processor, the diagram entity identifier to the architecture entity identifier to identify the project template as the project template associated with the diagram entity;
generate, using the processor, a project component from the identified project template, the project component corresponding to the diagram entity and populated with the component tasks from the identified project template; and
populate a project work plan with the project component.

14. The system of claim 13, wherein the architecture entity identifier and at least one diagram entity identifier are text-based.

15. The system of claim 13, wherein the architecture entity identifier and at least one diagram entity identifier are shape-based.

16. The system of claim 13, wherein the program instructions are executable by the processor to further:
update the project work plan to comport with a received update to the project architecture diagram; and
update the project architecture diagram to comport with a received update to the project work plan.

17. The system of claim 13, wherein the program instructions are executable by the processor to further:
store in the database an association between users and component tasks; and
automatically assign users to component tasks of the project component based on the association.

18. The system of claim 13, wherein the program instructions are executable by the processor to further:
accept an indicator that a first diagram entity is a predecessor of a second diagram entity; and
automatically set, in the project work plan, a first project component, associated with the first diagram entity, as a prerequisite dependency for a second project component, associated with the second diagram entity.

19. The system of claim 13, wherein the program instructions are executable by the processor to further:
associate a work investment percentage with each component task;
receive a component work investment necessary to complete each project component; and
determine, for each component task, a task work investment, the task work investment being a portion of the component work investment necessary to complete the component task, as based on the work investment percentage.

20. The system of claim 19, wherein the program instructions are executable by the processor to further determine a completion date for the project component, based at least on a start date, the component work investment, and the task work investments for each component task of the project component.

21. The system of claim 20, wherein the program instructions are executable by the processor to further determine a project completion date for the project work plan using at least the completion dates and the component work investments for each project component in the project work plan.

22. The system of claim 21, wherein the program instructions are executable by the processor to further populate the received project architecture diagram with the completion dates, the component work investments, the task work investments, and the project completion date.

23. The system of claim 22, wherein the program instructions are executable by the processor to further accept edits to the start dates, component work investments, task work investments and the project completion date within the project work plan and in the project architecture diagram.

24. The system of claim 13, wherein the diagram shape is associated with a release phase indicator, wherein the program instructions are executable by the processor to further:
designate the project work plan for a current release phase of a plurality of release phases; and
populate the project work plan with a project component corresponding to the diagram entity only when the release phase indicator for the diagram entity corresponds to the current release phase.
